(19) United States
(12) Patent Application Publication
(10) Pub. No.: US 2003/0139132 A1
(43) Pub. Date: Jul. 24, 2003

(54) Heating and/or air conditioning unit for a vehicle with a partial air guide duct

(76) Inventor: Siegfried Derx, Lichtenfels (DE)

Correspondence Address: Liniak Berenato, Longacre & White, Suite 240, 6550 Rock Spring Drive, Bethesda, MD, 20817, US

(21) Appl. No.: 10/130,502

(22) PCT Filed: Nov. 29, 2000
(86) PCT No.: PCT/EP00/11969

(30) Foreign Application Priority Data
Dec. 1, 1999 (DE) 19957859.1

(51) Int. Cl. B60H 3/00

(52) U.S. Cl. 454/156

(57) ABSTRACT

Heating and/or air conditioning unit for a vehicle having a heat exchanger (2, 4), to the outlet side of which a temperature flap (10), a duct which serves, at least in sections, as mixing chamber and/or distributor, an air flow control flap (12) and an air outlet are connected, at least one section of the duct containing a partial air guide duct (22) running essentially parallel in a duct-inside-a-duct arrangement, making it possible to carry a proportion of the heated and/or conditioned air essentially without interference from other air flows.

The present invention relates to a heating and/or air conditioning unit for a vehicle.

A heating and/or air conditioning unit for a vehicle usually comprises a heat exchanger, to the outlet side of which a temperature flap, a duct which serves, at least in sections, as mixing chamber and/or distributor, an air flow control flap and an air outlet are connected. In most cases engine coolant is admitted to the heat exchanger, it being also possible to provide an additional electrical heater, in the form of a PTC heating register, for example, downstream of the heat exchanger.

In recent years it has emerged that the user of a motor vehicle usually requires a so-called temperature layering, in which the air delivered to the foot well is conventionally to be provided at a higher temperature level than the air which is delivered to the head and upper body area of the occupants through the air outlets arranged on the dashboard. Attempts have hitherto been made to achieve this temperature layering by drawing the air from different points in the heating and air conditioning unit, an alternative approach being to introduce the air flows at different temperatures in a so-called mixing chamber, in such a way that a completely homogeneous mixing does not occur. Accordingly the aim is, by contrast, to produce the least possible swirling in the mixing chamber, so that slightly warmer air can be delivered to the foot area and air at a slightly lower temperature to the head and upper body area.

A heating and/or air conditioning unit that suggests such a virtual layering of air flows is described in FR-A-2562845. Apart from the difficulty of managing air flows at different temperatures without complete homogeneity occurring, one problem lies in providing sufficient warm air at a special point of delivery. One attempt to meet the requirements of the so-called defrost mode, in particular, is disclosed in FR-A-2650224, a duct being provided for supplying the defroster nozzles, which essentially extends vertically through the temperature-layered air flows.

The object of the present invention is to develop a known heating and/or air conditioning unit in such a way as to permit an air ducting that assists and/or modifies the temperature layering.

According to the invention, this object is achieved by a device having the features of claim 1. Preferred embodiments are defined in the dependent claims.

In particular, the present invention proposes a heating and/or air conditioning unit for a vehicle having a heat exchanger, to the outlet side of which a temperature flap, a duct which serves, at least in sections, as mixing chamber and/or distributor, an air flow control flap and an air outlet are connected, the unit according to the invention being characterized in that at least one section of the duct contains a partial air guide duct running essentially parallel in a duct-inside-a-duct arrangement, making it possible to carry a proportion of the heated and/or conditioned air essentially without interference from other air flows. In other words, the invention permits not only a virtual air flow layering but a real air flow layering, the air fed into the partial air guide duct experiencing almost no interference from other, for example colder air flows. As an example of the application of the solution according to the invention, it is possible to supply a correspondingly adjusted air flow rate at a desired correspondingly high temperature to the central outlet nozzles in the dashboard. It should be mentioned in particular in this context that the partial air flow guide according to the invention precludes the possibility not only of any temperature influence by other air flows, but also any speed-related influence.

In a preferred embodiment of the unit according to the invention, the partial air guide duct essentially extends vertically upward, so that a certain chimney effect can help to ensure that the warm air fed through is accelerated or delivered at a higher rate of flow.

In order to assist the chimney effect cited above, or for some alternative purpose, the partial air guide duct may advantageously contain air delivery means, it being possible also to provide an electrical heating device for the partial air flow passing through as an alternative or addition.

The partial air guide duct is advantageously situated at the point in the duct at which the flow path from the heat exchanger to the air outlet to be supplied is shortest. In other words, the flow path, which in any case leads to a minimal temperature difference between heat exchanger and outlet point, is isolated from other air flows.

In a preferred embodiment the partial air guide duct may be closed off by the air flow control flap of the associated duct section. Where partial air flow ducting for warm air is provided on the central air outlets in the dashboard, for example, closure of the air flow control flap for all the outlets on the dashboard can also serve to close the partial air flow duct.

In order to deliver a predominantly heated and/or conditioned air supply through the partial air guide duct, at least one air baffle element is advantageously connected upstream of the duct, in particular upstream of the temperature flap, which element when the temperature flap is opened directs the air in the partial air guide duct. In an especially preferred embodiment, said air baffle element may also be of adjustable design.

The partial air guide duct is advantageously situated essentially in the center of the duct in a direction perpendicular to the direction of travel of the vehicle. This arrangement allows air with a temperature greatly modified by the heat exchanger to be delivered to the central nozzle, so that the occupants can be provided with an agreeable warm air sensation at an adequate air flow rate even shortly after starting.

In a preferred embodiment, a part of the wall of the partial air guide duct forms a part of the wall of the duct itself. In other words, it is advantageous if the partial air guide duct divides off a segment of the overall duct.

The passage area of the partial air guide duct is advantageously less than ½ and in particular less than ⅓ of the overall passage area of the duct. This arrangement leaves a sufficient volume, in addition to the partial air guide duct, for air that may be mixed from cold air and warm air, which is to be fed to a corresponding outlet point or to another outlet point.

In order to minimize air flow noises, the partial air guide duct has a geometry of similar design to the duct.

Further advantages and features of the present invention are set forth in the following description, given purely as an example, of a currently preferred embodiment, reference being made to the drawings attached, in which:

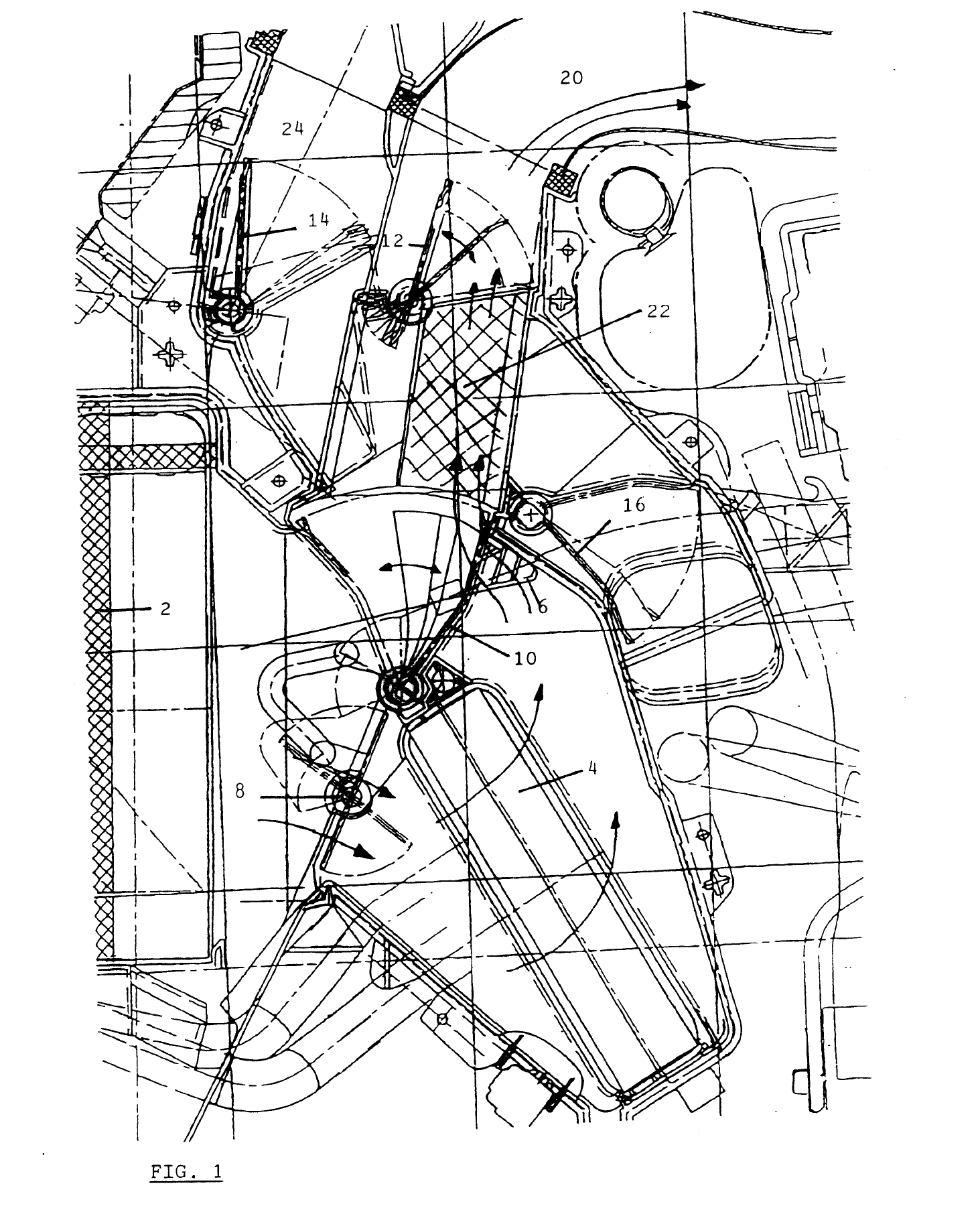

FIG. 1 shows a diagrammatic vertical section through a heating and/or air conditioning unit according to a preferred embodiment of the invention,

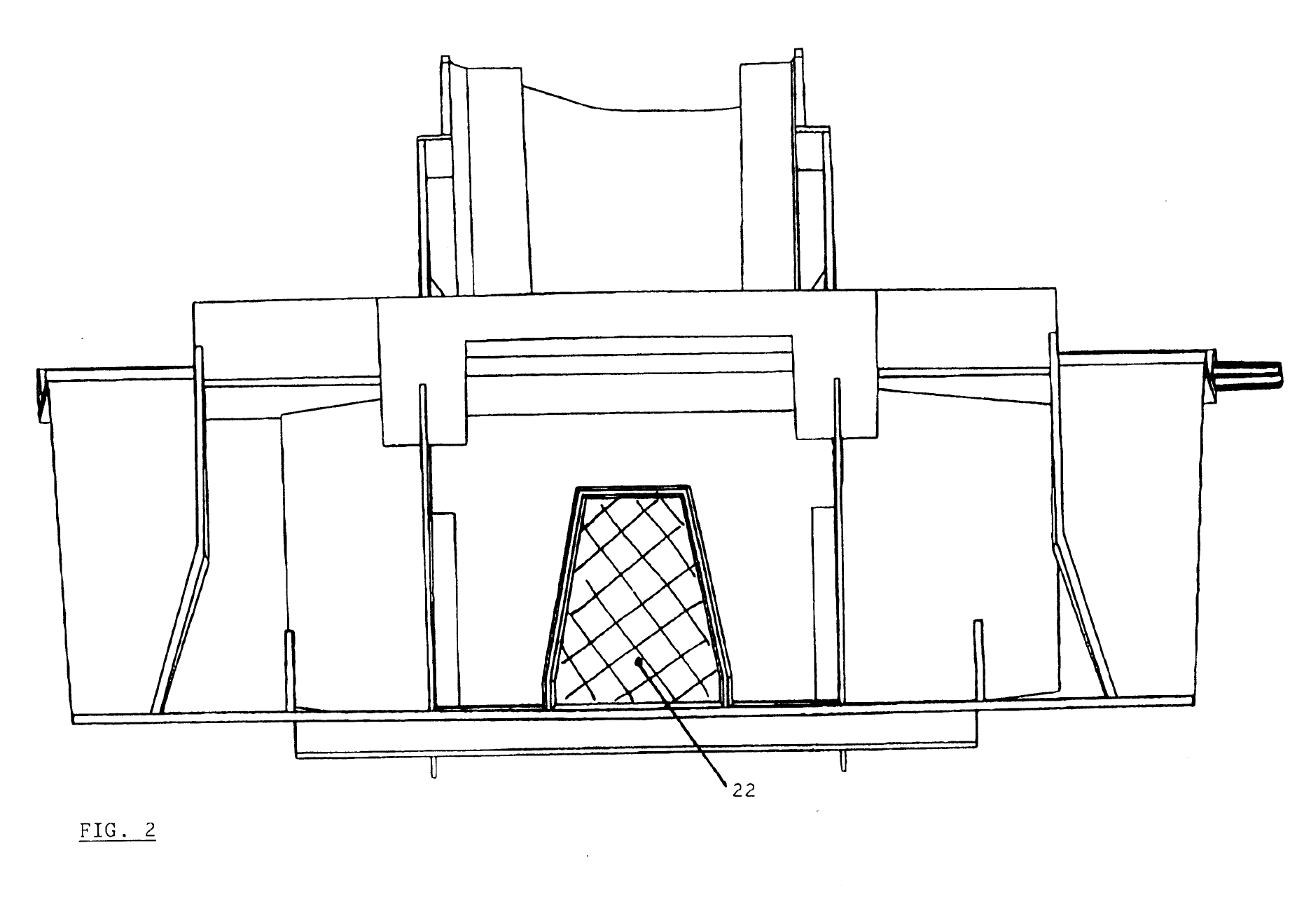

FIG. 2 shows parts of a horizontal section through the embodiment shown in FIG. 1, immediately above the temperature flap,

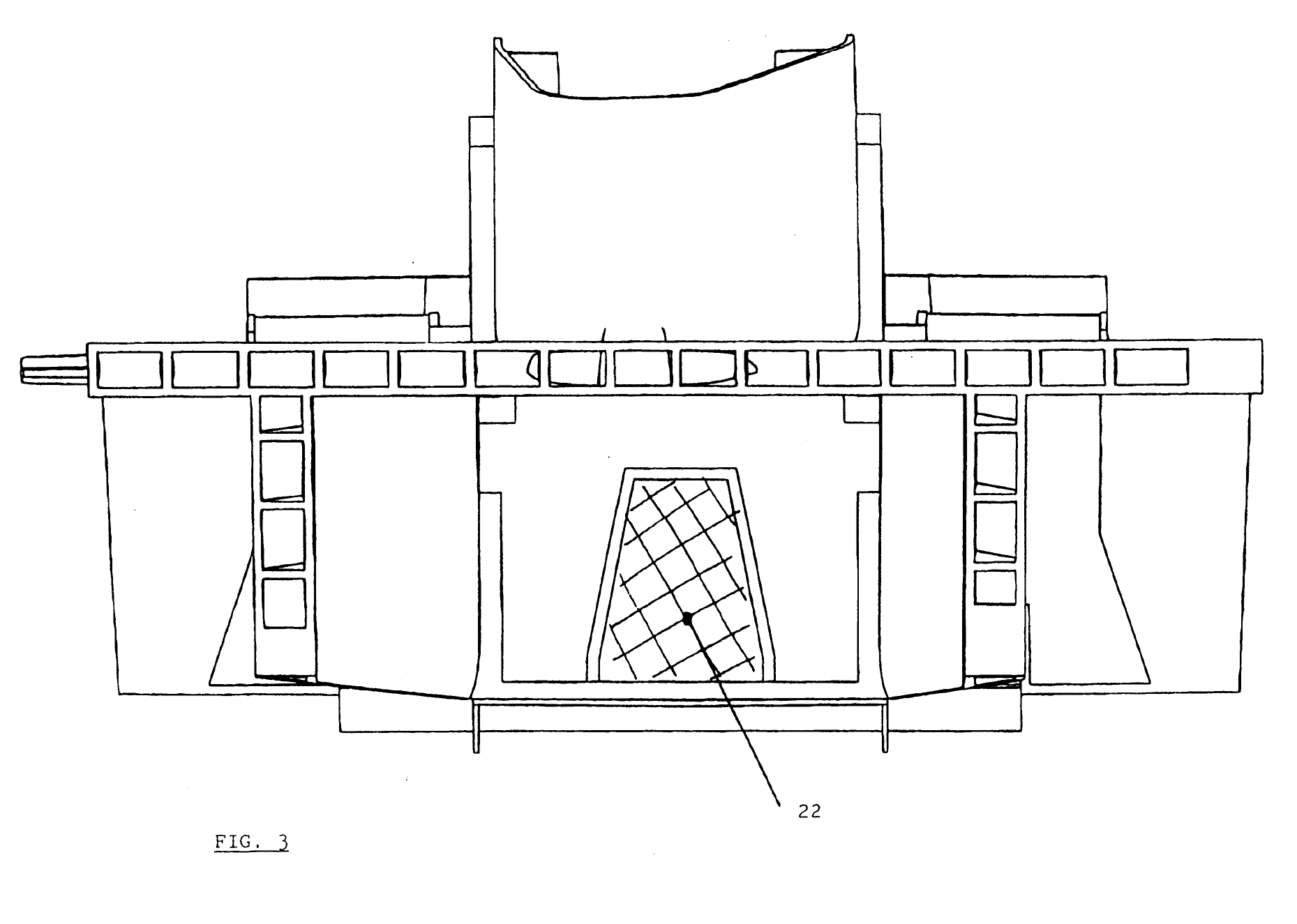

FIG. 3 shows a side view similar to FIG. 2, but at a level directly below the air flow control flap.

The heating and air conditioning unit represented in FIG. 1 conventionally comprises an evaporator 2, that can be acted upon by a fan (not shown). A proportion of the air emerging from the evaporator 2 is fed, according to the setting of a control flap 8, through a heating element, which on the fluid side is supplied with engine coolant. Although not shown, electrical heating, in the form of a PTC heating register, for example, can be connected downstream of the heat exchanger 4. That fraction of air coming from the evaporator 2 that is not fed through the heat exchanger 4 is made to bypass the heat exchanger 4, essentially above the latter, it being possible to control this air fraction by means of a so-called temperature flap 10. At the same time, the temperature flap 10 controls the quantity of air passing through the heat exchanger 4.

Any mixing that occurs between air heated by the heat exchanger 4 and air cooled by the evaporator 2 takes place at the take-off end of the temperature flap 10. In the embodiment shown, the area swept by the temperature flap 10 on the outer section is generally capable of feeding three duct sections, that is a so-called defrost duct 24, a dashboard air outlet duct 20 and a foot well air duct 26. Each of these duct sections 20, 24, 26 is provided with an air flow control means 12, 14 and 16 respectively, so that the respective duct can be selectively opened or shut off independently of the other duct sections.

The individual ventilation and/or air conditioning modes, usually selectable by the driver, are essentially represented by the control flap 8 and an interaction between the temperature flap 10 and the respective air flow control flaps 12, 14 and 16. In the so-called defrost mode, maximum warm air output is to be provided at the windshield. For this purpose the flap 8 and the temperature flap 10 are therefore each fully opened. The air heated by the heat exchanger 4 is therefore simultaneously available at the orifice areas of the ducts 20, 24, 26, the ducts 20 and 26 being closed by the respective air flow control means 12 and 16, so that the warm air is fed exclusively to the windshield. The person skilled in the art will appreciate that in this case a temperature layering is neither required nor advisable, especially since there is no possibility of interference by other air flows.

The present invention is therefore rather aimed at a situation in which the temperature flap 10 is in an intermediate position, or one in which other air flows are present in ducts or partial ducts 20, 24, 26 that have not been shut off (for example, cold air return flow from the foot well). In these cases the conventional temperature layering can often not lead to the desired temperature distribution. In the embodiment represented in FIG. 1, for example, the central nozzle at dashboard height is primarily to be supplied with warm air. According to the invention therefore, a partial air guide duct 22, which in the embodiment shown essentially extends from the temperature flap 10 to the closed position of the air flow control means 12 (in this case the central nozzle flap), is assigned to the duct 20 leading to this central nozzle on the orifice side, that is to say immediately adjoining the temperature flap.

The person skilled in the art will recognize that the partial air guide duct 22 forms a “warm air duct”, which describes the shortest flow path between the heat exchanger 4 and the central nozzle. By means of the discrete separation from any other air flows present, any interference, especially cooling, can be virtually eliminated. Owing to the essentially vertical course of this partial air guide duct, the rate of flow can be boosted by means of the chimney effect, a fan element (not shown) being optionally capable of replacing and/or assisting this function. The person skilled in the art will furthermore recognize that the arrangement of an electrical heater, such as a PTC heating register, in this area, that is to say inside the partial air guide duct 22 may be of advantage, for example, where the heating heat exchanger 4 cannot yet provide the desired heat output after starting the vehicle.

As is shown, the orifice area of the partial air guide duct essentially corresponds to the kinematics of the temperature flap 10. In order to direct the warm air emerging from the heat exchanger 4 preferably into the warm air duct 22 thus formed, air baffle elements 6 are provided, which on the whole concentrate the air flow into that area in which the partial air guide duct 22 is situated.

As can be seen more clearly from FIG. 2, the partial air guide duct occupies only a part of the overall cross section of the duct in question. In the embodiment shown, the area is equal to approximately one third of the overall air passage area, the two ducts, as shown, having a common wall section. As shown, the partial air guide duct essentially extends centrally in a direction perpendicular to the direction of travel of the vehicle, so that air present in the mixing area, that is to say downstream of the temperature flap, that is not fed through the partial air guide duct can be distributed as required to the ducts. In this context the person skilled in the art will appreciate the profile contour selected for the partial air guide duct, which allows the ducting system leading to the foot well to be fed advantageously in terms of the fluid mechanics.

In summing up, it will be noted that by means of a very simply designed arrangement of the duct section in question, a discrete separation of temperature flows at different temperatures can be achieved, providing a significantly improved adaptation to the needs of the occupants. In particular, if the partial air flow duct is provided between the air flow control flap of the duct in question and the temperature flap, as represented in the preferred embodiment, no further adaptation of the overall system is necessary, so that the concept according to the invention can be very easily implemented in existing heating and/or air conditioning units.

Although the invention has been described above entirely with reference to an example of a currently preferred embodiment, the person skilled in the art should recognize that widely varying adaptations and modifications are possible without departing from the scope of the disclosure. In particular, the person skilled in the art should recognize that the partial air flow duct is obviously not limited exclusively to the warmest fraction of the overall air flow, but can be similarly applied to the coldest fraction, or to any intermediate fraction. The relevant factor is rather that a selected part of the air flow available can be ducted in such a way that it is not subject, at least in sections, to unwanted influences from other air flows. This for one thing provides a more variable facility for adjustment of the user setting, it being possible to provide further enhancement in this area, such as air sensors or an output-side arrangement, such as the electrical heating device already mentioned. It should finally be mentioned that more than one partial air guide duct may be provided in one duct or one partial air guide duct in each partial duct section. It would be possible, for example, to provide two partial air guide ducts for the air outlets in the dashboard, whilst providing no partial air ducting for the defrost duct and only one partial air guide duct for the foot well area.

1. A heating and/or air conditioning unit for a vehicle having a heat exchanger (2, 4), to the outlet side of which a temperature flap (10), a duct which serves, at least in sections, as mixing chamber and/or distributor, an air flow control flap (12) and an air outlet are connected, characterized in that at least one section of the duct contains a partial air guide duct (22) running essentially parallel in a duct-inside-a-duct arrangement, making it possible to carry a proportion of the heated and/or conditioned air essentially without interference from other air flows.

2. The unit as claimed in claim 1, characterized in that the partial air guide duct essentially extends vertically.

3. The unit as claimed in claim 1 or 2, characterized in that the partial air guide duct (22) contains an air delivery means and/or an electrical heating device, especially a PTC heating device.

4. The unit as claimed in one of the preceding claims, characterized in that the partial air guide duct is arranged at the point in the duct at which the flow path from the heat exchanger (2, 4) to the air outlet is shortest.

5. The unit as claimed in one of the preceding claims, characterized in that the partial air guide duct can be closed by the air flow control flap of the duct section in question.

6. The unit as claimed in one of the preceding claims, characterized in that at least one air baffle element (6) is connected upstream of the duct and in particular of the temperature flap (10), which element when the temperature flap (10) is opened directs the air into the partial air guide duct (22).

7. The unit as claimed in one of the preceding claims, characterized in that the partial air guide duct (22) is arranged centrally in the duct, or in the duct section in question, in a direction running perpendicular to the direction of travel of the vehicle.

8. The unit as claimed in one of the preceding claims, characterized in that a part of the wall of the partial air guide duct forms a part of the wall of the duct or duct section in question.

9. The unit as claimed in one of the preceding claims, characterized in that the passage cross section of the partial air guide duct (22) represents less than ½ and in particular less than ⅓ of the passage cross section of the duct.

10. The unit as claimed in one of the preceding claims, characterized in that in its geometry the partial air guide duct (22) is of similar design to the duct or duct section in question.
